(19) United States
(12) Patent Application Publication
(10) Pub. No.: US 2009/0278803 A1
(43) Pub. Date: Nov. 12, 2009

(54) FACILITATING INPUT OF USER NAME AND PASSWORD FROM DEVICE HAVING KEYPAD LAYOUT DIFFERENT THAN KEYPAD LAYOUT OF DEVICE USED TO ESTABLISH USER NAME AND PASSWORD

(75) Inventor: MAHYAR NEJAT, La Jolla, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/119,029

(22) Filed: May 12, 2008

(51) Int. Cl. G06F 3/02

(52) U.S. Cl. 345/168

(57) ABSTRACT

If a user establishes a user name and password using a conventional telephone keypad and subsequently wishes to access the account using a PDA with a different key layout, the user is aided by displaying an image of the conventional telephone keypad on the PDA which the user can touch to input the user name and password and, thus, more easily access the account without having to remember anything more than the original numeric combination corresponding to the account information.

### I. FIELD OF THE INVENTION

The present invention relates generally to allowing a user, who has established account information including, e.g., user name and password using a device such as a conventional telephone keypad, to subsequently access the account by inputting the account information using another, different device such as a personal digital assistant/multi-purpose wireless telephone with a full QWERTY keypad.

### II. BACKGROUND OF THE INVENTION

A user who uses a device with a keypad having a particular number-to-letter correlation can establish account credentials with, e.g., an Internet server typically by establishing a user name and password for the account. These data items are entered using the keypad of the device. For instance, if a conventional telephone keypad is used by a person with an intent to enter the user name “John”, the number keys 5-6-4-6 are manipulated, because each of these keys corresponds to plural respective letters, i.e., “5” corresponds to “j”, “k”, and “l”; “6” corresponds to “m”, “n”, and “o”; and “4” corresponds to “g”, “h”, and “i”. While the person believes he has entered a particular user name, however, the server receiving the credentials thinks that the user name (or more generally credential being established) is the signal it received, in the above hypothetical, 5-6-4-6.

As understood herein, in the above example if the person wishes to reenter the user name “John” subsequently using the telephone keypad, the person presses 5-6-4-6, which is what the server recognizes to be the correct user name. However, if a different device with a keypad having a different number-to-letter correlation subsequently is desired to be used to access the account entry of the name or password is complicated. Recall that in the above hypothetical, the server thinks that the password is not “John” but rather is 5-6-4-6, but if the person wishes to access the account using, e.g., a PDA or other device with a full QWERTY keypad, the person believes that pressing the letters “J”, “O”, “H”, and “N” will suffice, when in reality the server recognizes only the numeric sequence 5-6-4-6 as being correct.

### SUMMARY OF THE INVENTION

A method is disclosed for allowing a user of an accessing device to access an electronic account having account credentials established by manipulating a first keypad of an establishing device having a first number-to-letter correlation. The accessing device has a second keypad with a second number-to-letter correlation different than the first number-to-letter correlation. The method includes presenting an image of the first keypad on a display of the accessing device to assist a user in inputting correct account credentials using the accessing device.

In one implementation the display is a touchscreen display, and the account credentials are entered by touching portions of the display representing keys of the first keypad. In another implementation the account credentials are entered by touching keys of the second keypad aided by viewing the display showing the first keypad.

The first number-to-letter correlation can be established by at least some keys each representing a respective number and plural letters as, for example, on a conventional telephone number pad. In contrast, the second number-to-letter correlation can be established in that no key of the second keypad represents more than a single number or letter. For example, each of some keys of the second keypad can represent one and only one number and one and only one letter, while other keys represent only a single letter each, as might be established on some QWERTY-type layouts of PDAs.

In another aspect, a computing device includes a display, a processor communicating with the display, and an accessing keypad communicating with the processor. The processor presents on the display an image of an establishing keypad. The establishing keypad has a different key layout than the accessing keypad. Account credential information of a user account can have been established by means of the establishing keypad, and the processor subsequently receives user input representing the account credential information and transmits the account credential information to an account server to access the user account.

In another aspect, an apparatus has a processor, a display communicating with the processor, and a first keypad having a first layout and communicating user input to the processor. The processor causes an image of a second keypad having a second layout different than the first layout to be presented on the display to aid a user in repeating the input of information previously input to a second device incorporating the second keypad.

The details of the present invention) both as to its structure and operation, can best be understood in reference to the accompanying drawings, in which like reference numerals refer to like parts, and in which:

### BRIEF DESCRIPTION OF THE DRAWINGS

FIG. 1 is a schematic plan view showing two devices having keypads of different number-to-letter correlations to illustrate present principles, with portions cut away for clarity;

FIG. 2 is a schematic plan view of the display of the second device presenting an image of the keypad of the first device; and

FIG. 3 is a flow chart of logic in accordance with present principles.

### DETAILED DESCRIPTION OF THE PREFERRED EMBODIMENT

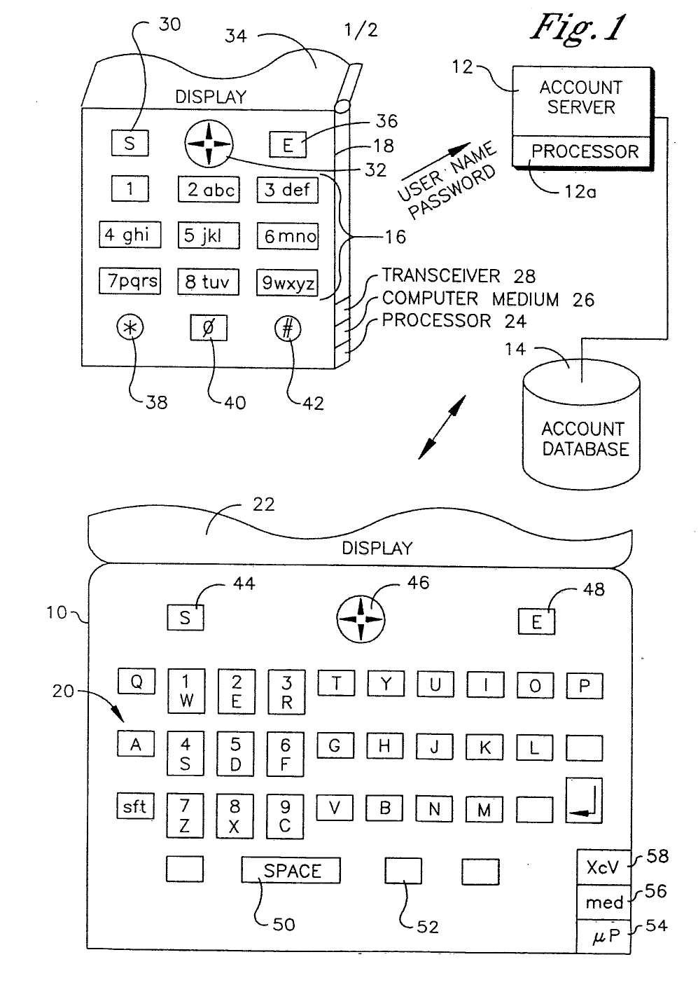

In some embodiments of the invention, a user of an accessing device 10 is allowed to access an electronic account in, e.g., an account server 12 with processor 12a and account database 14. The account has account credentials such as, e.g., user name and password that are established by manipulating a keypad 16 of an establishing device 16. It will readily be appreciated looking at FIG. 1 that the first keypad 16 has a first number-to-letter correlation while the accessing device has a keypad 20 with a second number-to-letter correlation that is different than the first number-to-letter correlation. As discussed further below, an image of the keypad 16 of the establishing device 18 is presented on a display 22 of the accessing device 10 to assist a user in inputting correct account credentials using the accessing device 10.

With greater specificity regarding the example embodiment shown in FIG. 1, the establishing device 18 may include a processor 24 that can access logic on and store data to a tangible computer readable medium 26 such as a disk or solid state storage. The establishing device may be a telephone, in which case it may include a transceiver 28 such as a wired communication interface or a wireless transceiver.

As shown in FIG. 1, the first number-to-letter correlation is established by at least some keys of the keypad 16 of the establishing device 18 each representing a respective number and plural letters. When the establishing device 18 is a telephone and its keypad 16 is a conventional telephone number keypad, some of the keys each represent one number and three or four letters as shown. Additional keys may be provided without loss of scope, including, for example, a “send” key 30, a cursor control key 32 for controlling Cursor presented on a display 34 of the establishing device 18, a transmission “end” key 36, a star key 38, a “zero” key 40, and a pound sign key 42.

In contrast, in the second number-to-letter correlation established by the keypad 20 of the accessing device 10, no one key represents more than a single letter or number. In fact, most of the keys represent at most a single letter; the keys representing the letters “W”, “F”, “R”, “S”, “D”, “F”, “Z”, “X”, and “C” each represent, in addition to a single letter, a respective single numeral, specifically, the numbers one through nine, it being understood that entirely separate number keys may be provided on the accessing device 10 if desired. In the non-limiting embodiment shown in FIG. 1, the keypad 20 includes a QWERTY keypad arrangement. Additional keys may be provided without loss of scope, e.g., a “send” key 44, a cursor control key 46 for controlling cursor presented on the display 22, a transmission “end” key 48, a space key 50, various additional keys 52, etc. Thus, the accessing device may be, without limitation, a PDA, a “Blackberry”™ phone, etc. that has a processor 54 that can access logic on and store data to a tangible computer readable medium 56 such as a disk or solid state storage and a transceiver 58 such as a wired communication interface and/or a wireless transceiver.

While specific devices are shown herein and designated as “establishing” and “accessing” devices, it is to be understood that their roles can be reversed. It is to be further understood that while account information established by the establishing device 18 and subsequently input by the accessing device 10 is envisioned, in general the invention may be used to aid a user in repeating the input of information using the accessing device 10 that was previously input using the establishing device 18 with different keypad layout.

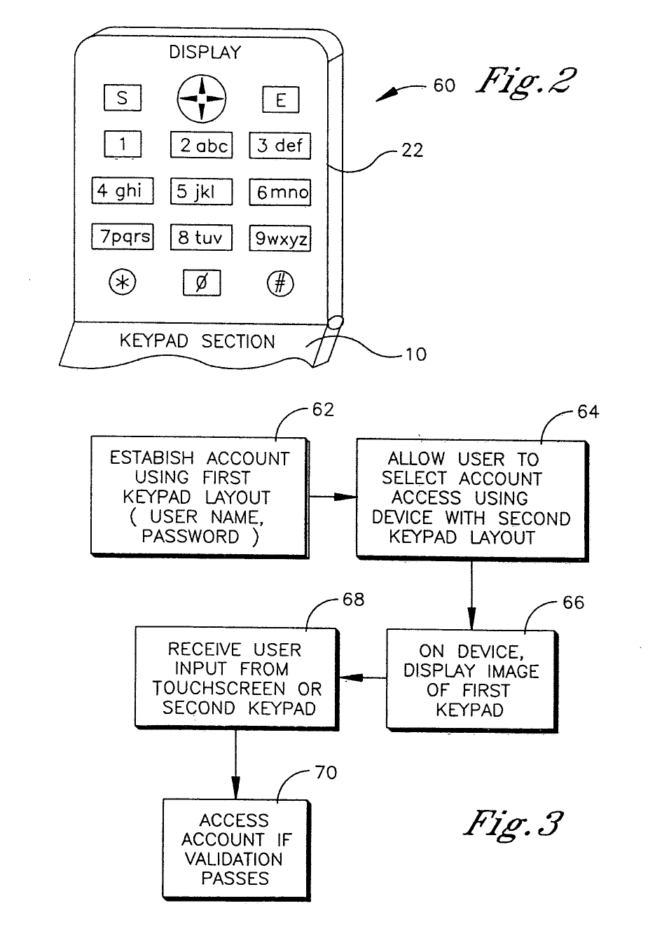

Now referring to FIGS. 2 and 3, a user of the accessing device 10 may cause an image 60 of the keypad 16 of the establishing device 18 to be presented on the display 22 of the accessing device 10. This may be done in any appropriate way that is not limiting to present principles. For example, the user may access a services menu and select an entry indicating a desire to present an image of a keypad different from the keypad 20 of the accessing device 10. In response, the processor 54 of the accessing device 10 may present a list of other keypads from which the user may select one, e.g., “telephone number pad”. The selected image is then displayed. Other methods for invoking the display of the image 60 may be used without loss of generality or scope.

The overall logic may be seen in reference to FIG. 3. At block 62 an account may be established, including account credentials, with the server 12 by appropriately manipulating the keypad 16 of the establishing device 18. At block 64 the user may be allowed to access the account using the accessing device 10 in accordance with principles above, i.e., the user may be allowed to cause an image of a different keypad to be displayed on the display 22 of the accessing device 10. As set forth above, at block 66 the image 60 of the keypad of the establishing device is presented on the display 22 of the accessing device 10, with user input then being received by the accessing device 10 at block 68. The account may be accessed at block 70 when the accessing device 10 transmits the account credentials to the server 12 and a user name and password match, for example, is found.

At block 68, the user input of the account credentials may be entered by the user touching portions of the display 22 representing keys of the keypad 16 of the establishing device 18, in which case the display 22 of the accessing device 10 can be a touch screen display. Or, the display 22 might not be a touch screen display, in which case the user can view the image 60 to understand what number keys on the keypad 20 of the accessing device 10 to touch.

While the particular FACILITATING, of INPUT OF USER NAME AND PASSWORD FROM DEVICE HAVING KEYPAD LAYOUT DIFFERENT THAN KEYPAD LAYOUT OF DEVICE USED TO ESTABLISH USER NAME AND PASSWORD is herein shown and described in detail, it is to be understood that the subject matter which is encompassed by the present invention is limited only by the claims.

What is claimed is:

1. A method for allowing a user of an accessing device to access an electronic account having account credentials established by manipulating a first keypad of an establishing device having a first number-to-letter correlation, the accessing device having a second keypad with a second number-to-letter correlation different than the first number-to-letter correlation, comprising:
presenting an image of the first keypad on a display of the accessing device to assist a user in inputting correct account credentials using the accessing device.

2. The method of claim 1, wherein the display is a touchscreen display, and the account credentials are entered by touching portions of the display representing keys of the first keypad.

3. The method of claim 1, wherein the account credentials are entered by touching keys of the second keypad aided by viewing the display showing the first keypad.

4. The method of claim 1, wherein the first number-to-letter correlation is established by at least some keys each representing a respective number and plural letters.

5. The method of claim 4, wherein the second number-to-letter correlation is established in that no key of the second keypad represents more than a single number or letter.

6. The method of claim 5, wherein each of at least some keys of the second keypad represent one and only one number and one and only one letter.

7. The method of claim 6, wherein the second keypad includes a QWERTY keypad arrangement and the first keypad includes a conventional telephone numeric keypad.

8. A computing device comprising:
a display;
a processor communicating with the display;
an accessing keypad communicating with the processor, the processor undertaking logic including:
presenting on the display, an image of an establishing keypad, the establishing keypad having a different key layout than the accessing keypad, account credential information of at least one user account having been established by means of the establishing keypad;
receiving user input representing the account credential information; and
transmitting the account credential information to an account server to access the user account.

9. The device of claim 8, wherein the establishing keypad has a first number-to-letter correlation and the accessing keypad has a second number-to-letter correlation different than the first number-to-letter correlation.

10. The device of claim 9, wherein the display is a touchscreen display, and the account credentials are received from touched portions of the display representing keys of the establishing keypad.

11. The device of claim 10, wherein the account credentials are received from touched keys of the accessing keypad aided by viewing the display showing the establishing keypad.

12. The device of claim 9, wherein the first number-to-letter correlation is established by at least some keys each representing a respective number and plural letters.

13. The device of claim 12, wherein the second number-to-letter correlation is established in that no key of the accessing keypad represents more than a single number or letter.

14. The device of claim 13, wherein each of at least some keys of the accessing keypad represent one and only one number and one and only one letter.

15. The device of claim 14, wherein the accessing keypad includes a QWERTY keypad arrangement and the establishing keypad includes a conventional telephone numeric keypad.

16. Apparatus, comprising:
a processor;
a display communicating with the processor; and
a first keypad having a first layout and communicating user input to the processor;
the processor causing an image of a second keypad having a second layout different than the first layout to be presented on the display to aid a user in repeating the input of information previously input to a second device incorporating the second keypad.

17. The apparatus of claim 16, wherein the display is a touchscreen display and the processor receives user input from the display.

18. The apparatus of claim 16, wherein the display is not a touchscreen display and the processor receives user input from the first keypad.

19. The apparatus of claim 16, wherein the first layout includes a QWERTY layout and the second layout includes a conventional telephone number pad layout.

20. The apparatus of claim 16, wherein the second layout includes a QWERTY layout and the first layout includes a conventional telephone number pad layout.
